(19) United States
(12) Patent Application Publication
(10) Pub. No.: US 2022/0282860 A1
(43) Pub. Date: Sep. 8, 2022

(54) LIGHTING SYSTEM

(71) Applicant: Contemporary Visions, LLC, Larchmont, NY (US)

(72) Inventors: Robert A. Sonneman, Mamaroneck, NY (US); Nuno Pires Da Silva, Lisboa (PT)

(73) Assignee: Contemporary Visions, LLC, Larchmont, NY (US)

(21) Appl. No.: 17/678,678

(22) Filed: Feb. 23, 2022

Related U.S. Application Data
(60) Provisional application No. 63/199,402, filed on Dec. 23, 2020.

(51) Int. Cl. F21V 23/06; F21S 4/28

(52) U.S. Cl. CPC F21V 23/06; F21S 4/28

(57) ABSTRACT

A modular lighting system that includes at one cylindrical luminaire that includes a power contact on at least one end that is contacted by a connector from which pins extend to transfer power. The lighting system can be mounted on a ceiling, wall or both at the same time with the luminaire being rotatable and the system being scalable.

### CROSS-REFERENCE TO RELATED APPLICATION

This patent application claims benefit to U.S. Provisional Patent Application No. 63/199,402, filed Dec. 23, 2020, which is hereby incorporated by reference in its entirety as part of the present disclosure.

### FIELD OF THE INVENTION

This present disclosure relates generally to a luminaire and more specifically to a scalable modular lighting system that that is configured to be mounted to a surface (e.g., wall, ceiling, a combination thereof or a similar structure) and that can include a plurality of luminaires adjoined to each other by connecters that allows for an infinite variety of lighting configurations.

### BACKGROUND OF THE INVENTION

Known modular lighting system come in various shapes and configurations ranging from a single lighting fixture to multiple lighting fixtures that are affixable to a surface (e.g., ceiling, wall or similar structure). However, such modular lighting systems do not allow for seamless and continuous electro-mechanical connectivity between luminaires that can be configured to be an array of possible arrangements.

### SUMMARY OF THE INVENTION

In general, the present disclosure is directed to a modular lighting system that are fixable to a surface or multiple surfaces (e.g., wall and ceiling) comprising one or more tubular luminaires and can be adjoined to each other or similar structures by connectors to form a variety of scalable arrangements that project light therefrom. The connectors include electrical projections or pins that extend therefrom and interact with a contact surface of the luminaire to provide power to the luminaire and allow for rotation of the luminaire with respect to the connector.

### BRIEF DESRIPTION OF THE DRAWINGS

FIGS. 1 and 2 are assembly views of a luminaire and connector according to an exemplary embodiment of the present disclosure;

FIGS. 3 and 4 are cross-sectional views of a luminaire in an assembled state with a connector according to an exemplary embodiment of the present disclosure;

FIG. 5 is a side view of a luminaire according to an exemplary embodiment of the present disclosure;

FIG. 6 is a perspective view of an end connector according to an exemplary embodiment of the present disclosure;

FIGS. 7A and 7B are assembly views of the end connector of FIG. 6 and a luminaire according to an exemplary embodiment of the present disclosure;

FIGS. 8A and 8B is a perspective view of an end connector and a canopy or end cap according to an exemplary embodiment of the present disclosure;

FIG. 9 is a perspective view of a linear connector according to an exemplary embodiment of the present disclosure;

FIGS. 10A and 10B are assembly views of the linear connector of FIG. 9 and a luminaire according to an exemplary embodiment of the present disclosure;

FIGS. 11A and 11B is a perspective view of a linear connector and a canopy or end cap according to an exemplary embodiment of the present disclosure;

FIG. 12 is a perspective view of a corner connector according to an exemplary embodiment of the present disclosure;

FIGS. 13A and 13B are assembly views of the corner connector of FIG. 12 and a luminaire according to an exemplary embodiment of the present disclosure;

FIG. 14 is a perspective view of a T-shaped connector according to an exemplary embodiment of the present disclosure;

FIGS. 15A and 15B are assembly views of the T-shaped corner connector of FIG. 14 and a luminaire according to an exemplary embodiment of the present disclosure;

FIG. 16 is a perspective view of a X-shaped connector according to an exemplary embodiment of the present disclosure;

FIGS. 17A and 17B are assembly views of the X-shaped corner connector of FIG. 16 and a luminaire according to an exemplary embodiment of the present disclosure;

FIG. 18 is a perspective view of a luminaire in an assembled state with a connector and being indicated as rotatable with respect to the connector;

FIGS. 19-23 are various views of lighting systems that incorporate at least one cylindrical luminaire and at least one connector according to exemplary embodiments of the present disclosure; and

FIGS. 24 and 25 are assembly views of at least one cylindrical luminaire and connectors according to exemplary embodiments of the present disclosure.

### DETAILED DESRIPTION OF EMBODIMENTS OF THE INVENTION

With reference now to the drawings, embodiments of a lighting system and elements thereof embodying the principles and concepts of the present invention will be described.

The lighting system includes one or more luminaires that is/are arranged between surface-mounted connectors and rotatable with respect to the connectors to direct light from the luminaire(s) at a desired angle (e.g., toward a wall, ceiling, etc.). The system is scalable such that the as few as a single luminaire and two connectors can be utilized or a plurality of luminaires and a plurality of connectors can be utilized to form the lighting system.

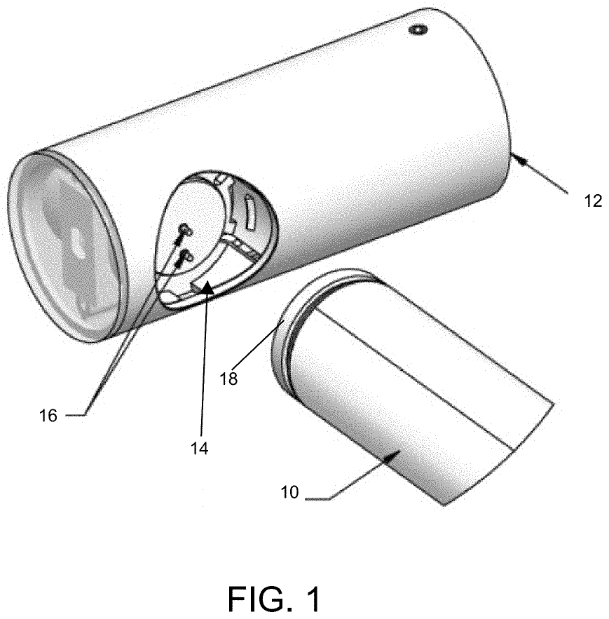

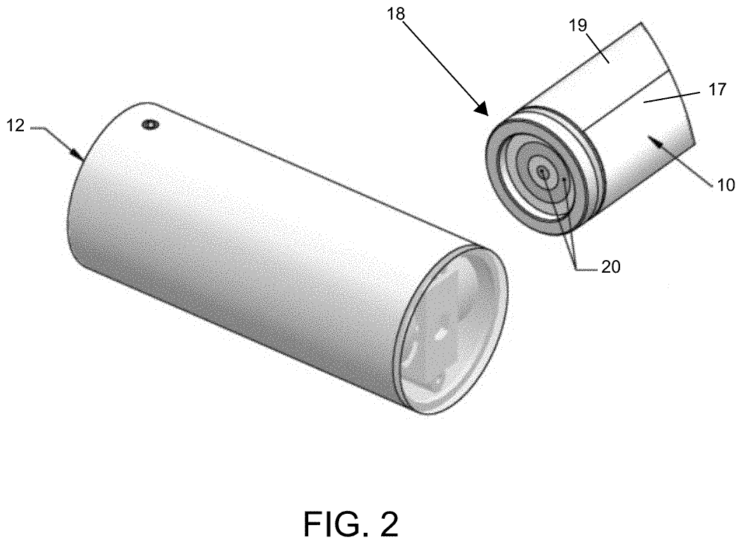

FIGS. 1 and 2 illustrate an assembly of a cylindrical luminaire 10 and a connector 12. The connector 12 includes an opening 14 from which contacts 16, which are spring pins, extend. As depicted in FIG. 2, the luminaire 10 includes a housing 17 that is delimited by recessed ends 18 that are configured to interact with the structure within the opening(s) 14 of the connector 12 and a surface 20 of a printed circuit board or the like that is configured to receive the contacts 16 so that power can be transferred from the connector 12 to the luminaire 10 to illuminate the luminaire 10. As part of the housing 102, the luminaire 10 includes a panel 104 that is in part is at least one of opaque, transparent, or the like to allow light from light sources 22 (See FIG. 4) project outward.

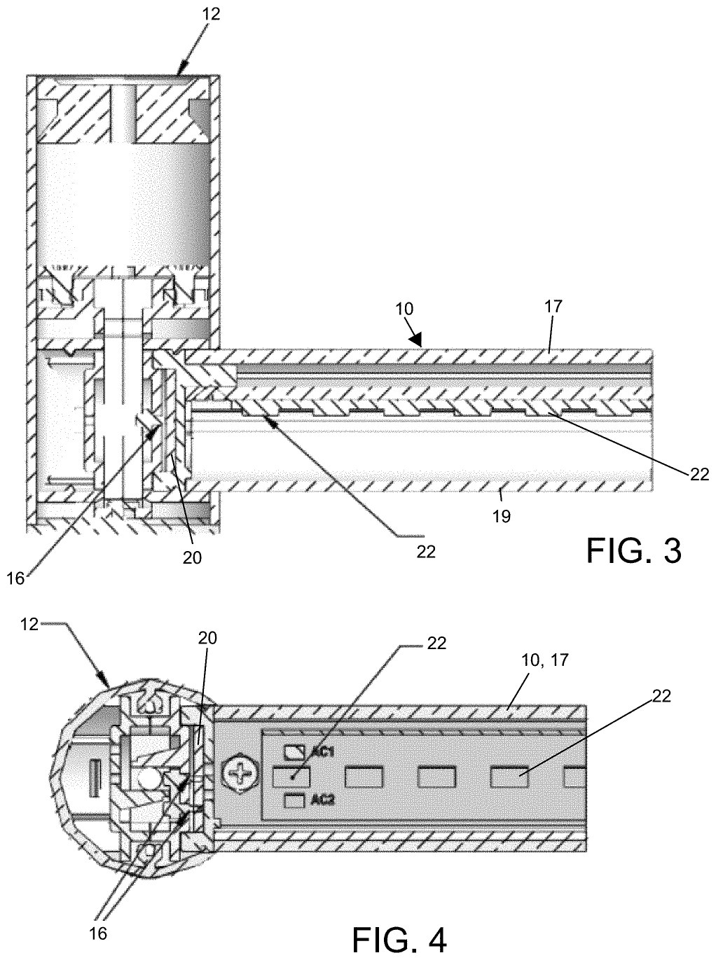

FIGS. 3 and 4 are cross-sectional views of the luminaire 10 and connector 12 in an assembled state. As shown, and end of the luminaire 10 is arranged in the opening 14 of the connector 12 and the spring pins 16 that extend from the connector 12 are in contact with the surface 20 of the luminaire. The luminaire 10 includes a plurality of light sources (LEDs) 22 that are configured to be illuminated upon power being provided thereto.

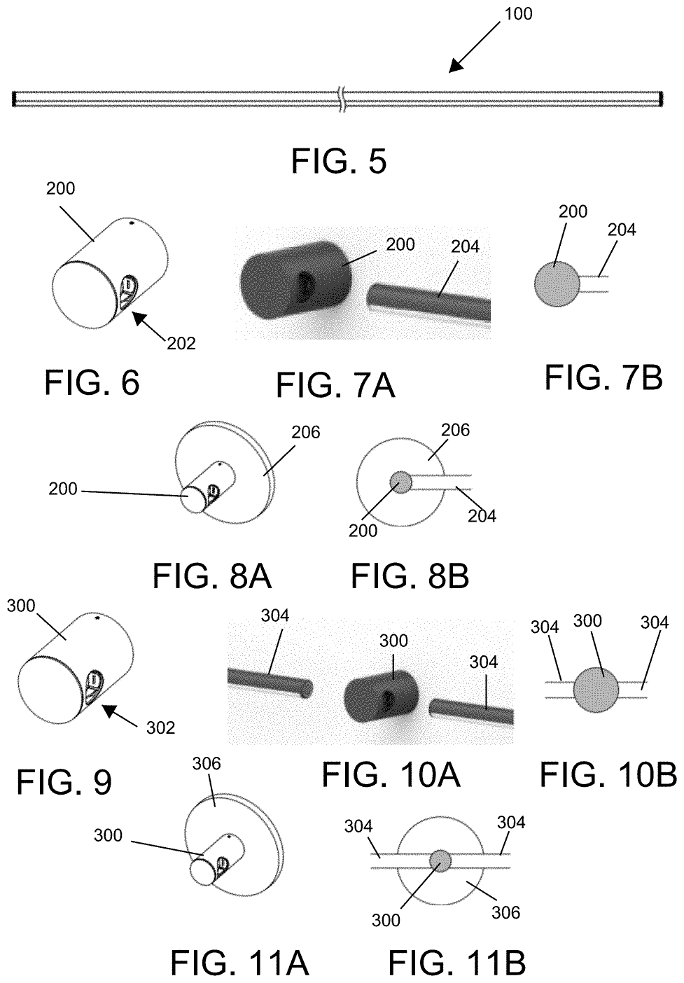

FIG. 5 depicts an exemplary embodiment of a luminaire 100 that can be utilized in conjunction with connectors to form a lighting system.

FIG. 6 illustrates an end connector 200 that includes a single opening 202 that has contacts (spring pins) that are configured to interact with a luminaire. FIGS. 7A and 7B show the assembly of the connector 200 with a luminaire 204 and FIG. 8 shows a canopy or end cap 206 for added decorative purposes encompassing a distal end of the connector 200 and configured to connect a surface.

FIG. 9 illustrates a linear connector 300 that includes two opening 302 that have contacts (spring pins) therein that are configured to interact with luminaires. FIGS. 10A and 10B show the assembly of the connector 300 and luminaires 304 and FIGS. 11A-11B show a canopy or end cap 306 for added decorative purposes encompassing a distal end of the connector 300 that is configured to connect a surface.

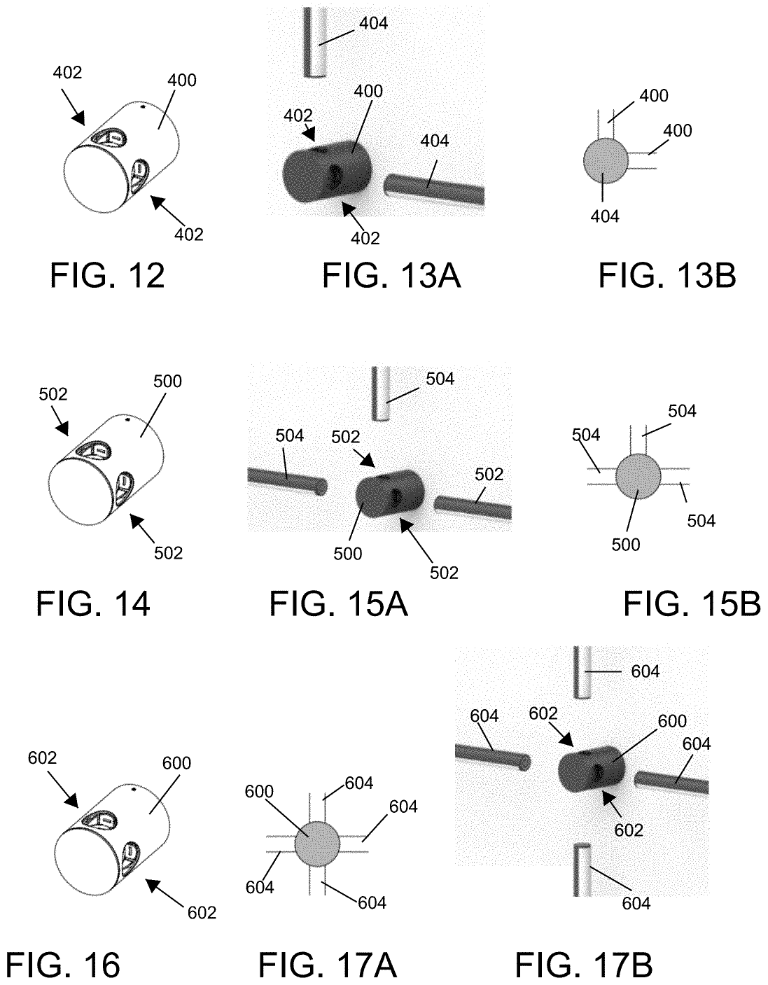

FIG. 12 illustrates a corner connector 400 that includes two opening 402 that have contacts (spring pins) therein that are configured to interact with luminaires 404. FIGS. 13A and 13B show the assembly of the connector 400 and the luminaires 404. As can be seen in an assembled state, the luminaires 404 are orientated at about 90 degrees with respect to each other by the connector 400.

FIG. 14 illustrates a T-shaped connector 500 that includes three opening 502 that have contacts (spring pins) therein that are configured to interact with luminaires 504. FIGS. 15A and 15B show the assembly of the connector 500 and the luminaires 504. As can be seen in an assembled state, the luminaires 504 are orientated at about 90 degrees with respect to each other by the connector 500 to form a T-shape.

FIG. 16 illustrates a X-shaped connector 600 that includes three opening 602 that have contacts (spring pins) therein that are configured to interact with luminaires 604. FIGS. 17A and 17B show the assembly of the connector 600 and the luminaires 604. As can be seen in an assembled state, the luminaires 604 are orientated at about 90 degrees with respect to each other by the connector 600 to form a X-shape.

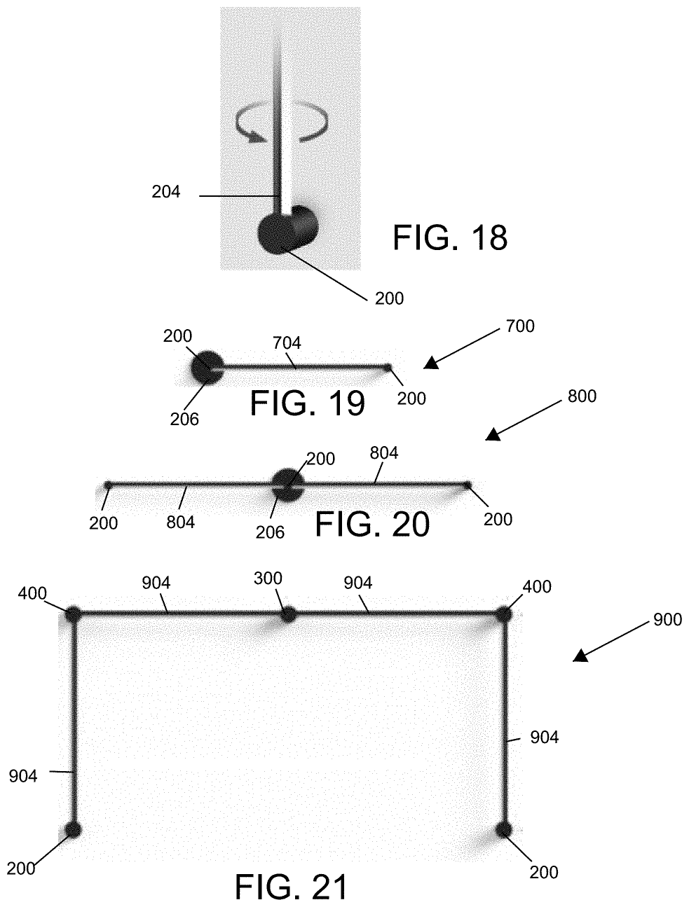

FIG. 18 illustrates a luminaire 204 that is rotatable with respect to the connector 200 in an assembled state.

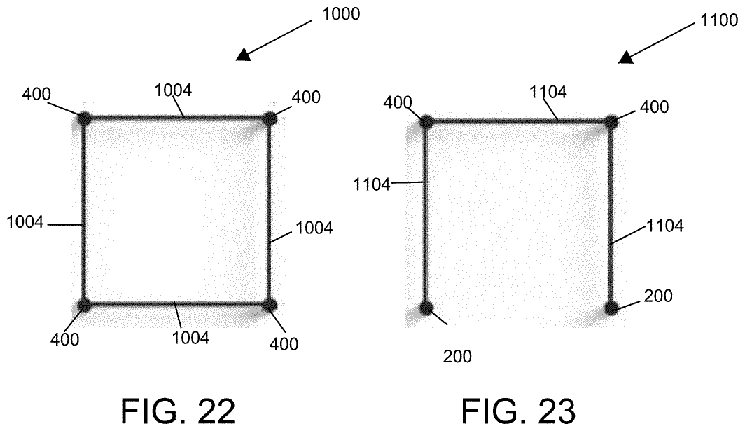

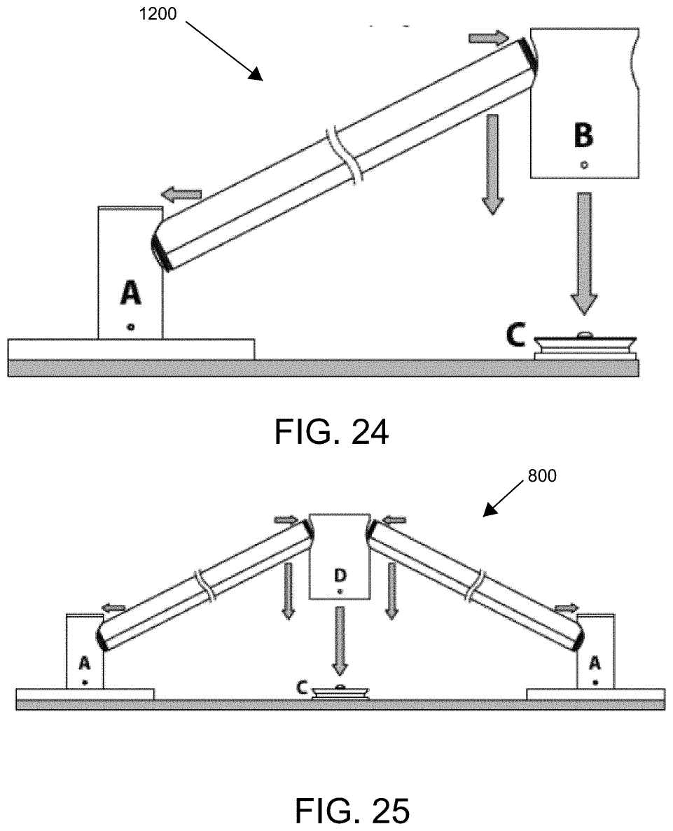

FIGS. 19-23 illustrate exemplary embodiments of lighting systems 700, 800, 900, 1000, 1100 that are comprised of at least one luminaire 704, 804, 904, 1004, 1104, respectively, and two connectors to delimit each luminaire at each end thereof.

FIGS. 24 and 25 are assembly views 1200, 1300 of lighting systems. The mounting brackets of the connectors are fixed to a surface by, for example, a fastener. Next one end of a luminaire is placed in an opening of a connector and then the other end of the luminaire is placed in an opening of another connector. The connectors are then secured to the mounting brackets.

Although the description above and accompanying drawings contains much specificity, the details provided should not be construed as limiting the scope of the embodiments, but merely as describing some of the features of the embodiments. The description and figures should not to be taken as restrictive and are understood as broad and general teachings in accordance with the present invention. While the embodiments have been described using specific terms, such description is for illustrative purposes only, and it is to be understood that modifications and variations to such embodiments, including, but not limited to, the substitutions of equivalent features and terminology may be readily apparent to those of skill in the art based upon this disclosure without departing from the spirit and scope of the invention.

What is claimed is:

1. A lighting system, comprising:
at least one cylindrical luminaire delimited at a first end and a second end, an electrical contact surface being arranged at at least one of the first end and the second end of the cylinder; and
at least one connector that includes at least one opening in which electrical projections extend that are configured to interact with and contact the contact surface at the end of the luminaire to both transfer power and secure the luminaire to a surface.
